(19) United States
(12) Patent Application Publication
(10) Pub. No.: US 2013/0151448 A1
(43) Pub. Date: Jun. 13, 2013

(54) APPARATUS AND METHODS FOR IMPLEMENTING LEARNING FOR ANALOG AND SPIKING SIGNALS IN ARTIFICIAL NEURAL NETWORKS

(71) Applicant: Filip Ponulak, San Diego, CA (US)

(72) Inventor: Filip Ponulak, San Diego, CA (US)

(21) Appl. No.: 13/313,826

(22) Filed: Dec. 7, 2011

(51) Int. Cl. G06N 3/08

(52) U.S. Cl. 706/25

(57) ABSTRACT

Apparatus and methods for universal node design implementing a universal learning rule in a mixed signal spiking neural network. In one implementation, at one instance, the node apparatus, operable according to the parameterized universal learning model, receives a mixture of analog and spiking inputs, and generates a spiking output based on the model parameter for that node that is selected by the parameterized model for that specific mix of inputs. At another instance, the same node receives a different mix of inputs, that also may comprise only analog or only spiking inputs and generates an analog output based on a different value of the node parameter that is selected by the model for the second mix of inputs. In another implementation, the node apparatus may change its output from analog to spiking responsive to a training input for the same inputs.

### CROSS-REFERENCE TO RELATED APPLICATIONS

This application is related to co-owned U.S. patent application Ser. No. 13/238,932 filed Sep. 21, 2011, and entitled “ADAPTIVE CRITIC APPARATUS AND METHODS”, U.S. patent application Ser. No. 13/______, attorney docket BRAIN.010C1, filed herewith, entitled, “APPARATUS AND METHODS FOR IMPLEMENTING LEARNING FOR ANALOG AND SPIKING SIGNALS IN ARTIFICIAL NEURAL NETWORKS”, and U.S. patent application Ser. No. 13/______, attorney docket BRAIN.010DV1, filed herewith, entitled, “NEURAL NETWORK APPARATUS AND METHODS FOR SIGNAL CONVERSION”, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates to machine learning apparatus and methods, and in particular, to learning with analog and/or spiking signals in artificial neural networks.

2. Description of Related Art

An artificial neural network (ANN) is a mathematical or computational model that is inspired by the structure and/or functional aspects of biological neural networks. A neural network comprises a group of artificial neurons (units) that are interconnected by synaptic connections. Typically, an ANN is an adaptive system that is configured to change its structure (e.g., the connection configuration and/or neuronal states) based on external or internal information that flows through the network during the learning phase.

Artificial neural networks are used to model complex relationships between inputs and outputs or to find patterns in data, where the dependency between the inputs and the outputs cannot be easily attained (Hertz J., Krogh A., and Palmer R. (1991) Introduction to the Theory of Neural Networks, Addison-Wesley, incorporated herein by reference in its entirety).

Neural Networks offer improved performance over conventional technologies in areas which include machine vision, pattern detection and pattern recognition, signal filtering, data segmentation, data compression, data mining, system identification and control, optimization and scheduling, complex mapping. For more details on applications of ANN we refer e.g. to Haykin, S., (1999), Neural Networks: A Comprehensive Foundation (Second Edition), Prentice-Hall or Fausett, L. V., (1994), Fundamentals of Neural Networks: Architectures, Algorithms And Applications, Prentice-Hall, each incorporated herein by reference in its entirety

### Neuron Models

An artificial neuron is a computational model inspired by natural, biological neurons. Biological neurons receive signals through specialized inputs called synapses. When the signals received are strong enough (surpass a certain threshold), the neuron is activated and emits a signal through its output. This signal might be sent to another synapse, and might activate other neurons. Signals transmitted between biological neurons are encoded in sequences of stereotypical short electrical impulses, called action potentials, pulses, or spikes.

### Analog Neuron Models

The complexity of real neurons is highly abstracted when modeling artificial neurons. A schematic diagram of an artificial neuron is illustrated in FIG. 1. The model comprises a vector of inputs x=[x₁, x₂ . . . xₙ]^{T}, a vector of weights w=[w₁, . . . , wₙ] (weights define the strength of the respective signals), and a mathematical function which determines the activation of the neuron's output y. The activation function may have various forms. In the simplest neuron models, the activation function is a linear function and the neuron output is calculated as:

y=wx (1)

More details on artificial neural networks can be found e.g. in Hertz J., Krogh A., and Palmer R. (1991), discussed supra.

### Spiking Neuron Models

Models of artificial neurons, like the one described by Eqn. 1, typically perform signal transmission by using the rate of the action potentials for encoding information. Hence, signals transmitted in these ANN models typically have analog (floating-point) representation, which are useful for representing continuous (analog) systems. Recent physiological experiments indicate, however, that in many parts of the biological nervous system, information processing is founded on the timing of individual action potentials. This finding has given rise to the emergence of a new class of neural models, called pulsed or spiking neural networks (SNNs).

Hence, SNNs represent a special class of ANN, where neuron models communicate by sequences of spikes (see Gerstner W. and Kistler W. (2002) Spiking Neuron Models, Single Neurons, Populations, Plasticity, Cambridge University Press, incorporated herein by reference in its entirety).

Most common spiking neuron models use the timing of spikes, rather than the specific shape of spikes, in order to encode neural information. A spike “train” can be described as follows:

$$S ( t ) = {\sum }_{f} δ ( t - {t}^{f} ) , \qquad ( Eqn . 2 )$$

where ζ=1, 2, . . . is the spike designator and δ(.) is the Dirac function with δ(t)=0 for t≠0 and

∫_{-∞}δ(t)dt=1. (3)

Various spiking neuron models exist, such as, for example: Integrate-and-Fire (IF) and a Leaky-Integrate-and-Fire (LIF) neurons, also referred to as the units (see e.g., Lapicque 1907, Stein 1967, each of the foregoing incorporated herein by reference in its entirety). The dynamics of a LIF unit is described as follows:

$$C \frac{d u}{d t} ( t ) = - \frac{1}{R} u ( t ) + ( {i}_{o} ( t ) + \sum {w}_{j} {i}_{j} ( t ) ) , \qquad ( Eqn . 4 )$$

where:
u(t) is the model state variable (corresponding to the neural membrane potential of a biological neuron);
C is the membrane capacitance;
R is the input resistance;
iₒ(t) is the external current driving the neural state;
iⱼ(t) is the input current from the j-th synaptic input; and
wj represents the strength of the j-th synapse.

When the input resistance R→∞, Eqn. 4 describes the IF model. FIG. 1A illustrates one example of a typical neuron response to stimulation. In both IF and LIF models, a neuron is configured to fire a spike at time t^{f}, whenever the membrane potential u(t) (denoted by the traces 114, 128 in FIG. 1A) reaches a certain value u, referred to as the firing threshold, denoted by the line 118 in FIG. 1A. Immediately after generating an output spike, the neuron state is reset to a new value uᵣₑₛ<u and the state is held at that level for a time interval representing the neural absolute refractory period. As illustrated in FIG. 1A, the extended stimulation of the node by the input signal 113 triggers multiple high excitability u(t) events within the node (as shown by the pulsing events 115 in FIG. 1A) that exceed the firing threshold 118. These events 115 result in the generation of the pulse train 116 by the node.

Biological neurons communicate with one another through specialized junctions called synapses (Sherrington 1897, Bennett 1999, each of the foregoing incorporated herein by reference in its entirety). Arrival of a pre-synaptic spike (illustrated by the spike train 120 in FIG. 1A) at a synapse provides an input signal i(t) into the post-synaptic neuron. This input signal corresponds to the synaptic electric current flowing into the biological neuron, and may be modeled as using an exponential function as follows:

i(t)=∫₀^{∞}S(t−s)exp(−s/τₛ)ds, (5)

where τₛ is the synaptic time constant and S(t) denotes here a pre-synaptic spike train. A typical response of the synapse model given by Eqn. 5 to a sample input spike train 120 is illustrated by the curve labeled 123 in FIG. 1A. The neuron potential u(t) in response to the spike train 120 is depicted by the line 128 in FIG. 1A.

Similarly to the analog input, the spiking input 120 into a node triggers a synaptic input current, which in an exemplary embodiment has a shape of a trace 123. The trace 128 depicts internal state of the node responsive to the synaptic input current 123. As shown in FIG. 1A, a single input pulse 122 of the pulse train 120 does not raise the node state above the firing threshold 118 and, hence, does not cause output spike generation. Pulse groups 124, 126 of the pulse train 120 cause the node state (excitability) to reach the firing threshold and result in the generation of output pulses 132, 134, respectively. A review of exemplary spiking neuron models is provided by Gerstner and Kistler 2002, incorporated by reference supra.

Spiking neural networks offer several benefits over other classes of ANN, including without limitation: greater information and memory capacity, richer repertoire of behaviors (tonic/phasic spiking, bursting, spike latency, spike frequency adaptation, resonance, threshold variability, input accommodation and bi-stability), as well as efficient hardware implementations.

In many models of ANN, it is assumed that weights are the parameters that can be adapted. This process of adjusting the weights is commonly referred to as “learning” or “training”.

Supervised learning is one of the major learning paradigms for ANN. In supervised learning, a set of example pairs (x,y^{d}), xεX, y^{d}εY are given, where X is the input domain and Y is the output domain, and the aim is to find a function ƒ:X→Y in the allowed class of functions that matches the examples. In other words, we wish to infer the mapping implied by the data. The learning process is evaluated using a so-called “cost function”, which quantifies the mismatch between the mapping and the data, and it implicitly contains prior knowledge about the problem domain. A commonly used cost is the mean-squared error, which tries to minimize the average squared error between the network's output, y, and the target value y^{d} over all the example pairs.

### Widrow-Hoff Rule

The delta rule was one of the first supervised learning algorithms proposed for ANN (Widrow B, Hoff. M. E. (1960) Adaptive Switching Circuits. IRE WESCON Convention Record 4: 96-104, incorporated herein by reference in its entirety). For temporal signals and for continuous time, the delta rule can be defined as:

\dot{w}ⱼᵢ(t)=η(yⱼ^{d}(t)−yⱼ(t))xᵢ(t), (6)

where wⱼᵢ(t) is the efficacy of the synaptic coupling from neuron i to j; \dot{w}ⱼ(t) is its time derivative; η constant is the learning rate; yⱼ^{d}(t) is the target signal for neuron j; yⱼ(t) is the output from neuron j; xᵢ(t) is the signal coming to neuron j through the i-th synaptic input.

The delta learning rule given by Eqn. 6, although developed originally for non-spiking neuron models like the one given by Eqn. 1, can also be applied to the spiking neuron models such as e.g. the one given by Eqn. 4., given the assumption that the signals yⱼ^{d}(t), yⱼ(t), xᵢ(t) represent the instantaneous firing rates of the target signals, output from the neuron and inputs to the neuron, respectively. That is: yⱼ^{d}(t)=<Sⱼ^{d}(t)>, yⱼ(t)=<Sⱼ(t)>, xᵢ(t)=<Sᵢ(t)>, where <Sⱼ^{d}(t)>, <Sⱼ(t)> are the instantaneous firing rates of the target and output spike trains of neuron j, respectively; <Sᵢ(t)> is the instantaneous firing rate of the input spike train entering the neuron through the i-th synaptic input; and all the spike trains are defined using Eqn. 4.

### ReSuMe Rule

In order to control directly the timing of the particular spikes generated by spiking neurons, another supervised learning rule, called ReSuMe has been proposed (see e.g., Ponulak, F., (2005), ReSuMe—New supervised learning method for Spiking Neural Networks. Technical Report, Institute of Control and Information Engineering, Poznan University of Technology; and Ponulak, F., Kasinski, A., (2010) Supervised Learning in Spiking Neural Networks with ReSuMe: Sequence Learning, Classification and Spike-Shifting. Neural Comp., 22(2): 467-510, each of the foregoing incorporated herein by reference in its entirety).

The ReSuMe learning rule is given by the following formula:

\dot{w}ⱼᵢ(t)=η(Sⱼ^{d}(t)−Sⱼ(t) S̅ᵢ(t), (7)

where, again: Sⱼ^{d}(t) is the target spike train for neuron j; Sⱼ(t) is the output spike train from j; and S̅ᵢ(t) is a low-pass filtered version of the i-th input spike train Sᵢ(t) to neuron j.

In general, we define the low-pass filtered version of the spike train Sₖ(t) as:

S̅ₖ(t)=∫₀^{∞}aₖ(s)Sₖ(t−s)ds (Eqn. 8)

with a(s) being a smoothing kernel (exponential, Gaussian, etc.) with a certain set of parameters, including e.g. the filter time constants τ. For example, an exponential smoothing kernel may be defined as:

aₖ(s)=exp(−s/τ), (Eqn. 9)

where s is an input argument to the function and τ is the time constant.

Whereas the delta rule given by Eqn. 5 controls the overall neural firing rate, the ReSuMe rule given by Eqn. 7 controls timing of individual spikes in a neural spike trains produced by neurons that are being subjected to the training, However, in different engineering applications that utilize spiking neuron models, different signal encoding methods are often used concurrently. By way of example, in some systems/tasks information is encoded in the neural firing rate, whereas in other systems/tasks information is encoded based on the precise timing of spikes.

Most existing methodologies for implementing learning for analog and spiking signals in artificial neural networks employ different node types and learning algorithms configured to process only one, specific signal type, for example, only analog or only spiking signal type. Such an approach has several shortcomings, such as, for example, the necessity to provide and maintain learning rules and nodes of different types, node duplication and proliferation, if the network is configured to process signals of the mixed types (analog and spiking). Network configurations, comprising nodes of different types, therefore prevent dynamic node reconfiguration and reuse during network operation. Furthermore, learning methods of prior art that are suitable for learning for analog signals are not suitable for learning for spike-timing encoded signals. Similarly learning rules for spike-based signals are not efficient in training neural networks for processing analog signals.

Based on the foregoing, there is a salient need for apparatus and method for implementing unified approach to learning and training of artificial neuronal network comprising spiking neurons that receive and process spiking and analog inputs.

### SUMMARY OF THE INVENTION

The present invention satisfies the foregoing needs by providing, inter alia, apparatus and methods for implementing learning in artificial neural networks.

In one aspect of the invention, a method of operating a node in a computerized neural network is disclosed. In one embodiment, the method comprises: combining at the node at least one spiking input signal and at least one analog input signal using a parameterized rule configured to effect output generation by the node; based at least in part on the at least one spiking signal and the at least one analog signal, modifying a parameter of the parameterized rule; and generating an output signal by the node based at least in part on the rule having the modified parameter.

In one variant, the parameter is associated with the node; the node comprises a spiking neuron and a set of synapses configured to provide input signals to the neuron; and the neuron and the set of synapses are operated, at least in part, according to the parameterized rule.

In another variant, the output comprises a spiking signal, or alternatively an analog signal.

In yet another variant, the parameterized rule comprises a supervised learning rule, and the modifying the parameter is configured based at least in part on a target signal, the target signal representative of a desired node output. The supervised learning rule comprises e.g., an online method configured to effect the modifying the parameter prior to any other input signal being present at the node subsequent to the at least one spiking input signal and the at least one analog input signal.

In another aspect of the invention, a computer implemented method of operating a neural network is disclosed. In one embodiment, the method comprises: processing at the node at least one spiking input signal and at least one analog input signal using a parameterized rule; based at least in part on the at least one spiking signal and the at least one analog signal, modifying a parameter of the parameterized rule; and generating an output signal by the node based at least in part on the modifying the parameter and in accordance with the parameterized model. In one variant, the parameter is associated with the node.

In another variant, the method further comprises updating a node characteristic based at least in part on the modifying the parameter, the characteristic comprising at least one of (i) integration time constant, (ii) firing threshold, (iii) resting potential, (iv) refractory period, and/or (v) level of stochasticity associated with generation of the output signal. Alternatively, the characteristic may comprise at least one of (i) node excitability, (ii) node susceptibility, and (iii) node inhibition.

In a further variant, the parameterized rule comprises a supervised learning rule, and the updating the node characteristic is configured based at least in part on a target signal, the target signal representative of a desired node output.

In a third aspect of the invention, a computer implemented method of operating a heterogeneous neuronal network comprising a node and a plurality of synaptic connections is disclosed. In one embodiment, the method comprises: receiving at the node via the plurality of synaptic connections at least one spiking input signal and at least one non-spiking input; based at least in part on the receive, modifying at least one parameter of a parameterized rule configured to effect output generation by the node; and generating an output signal by the node based at least in part on the modified at least one parameter.

In a fourth aspect of the invention, a computer implemented method of optimizing learning in a mixed signal neural network comprising a first and a second nodes is disclosed. In one embodiment, the first and the second nodes are operable according to a parameterized rule that is characterized by a first and a second parameter, and the method comprises: modifying, in accordance with the parameterized rule, the first parameter based at least in part on a first group of analog inputs being received by the first node; updating, in accordance with the parameterized rule and based at least in part on the modified first parameter, a first characteristic associated with the first group of inputs; modifying, in accordance with the parameterized rule, the second parameter based at least in part on a second group of spiking inputs being received by the second node; and updating, in accordance with the parameterized rule and based at least in part on the modified second parameter, a second characteristic associated the second group of inputs.

In one variant, the first characteristic is associated with a first synaptic connection configured to deliver an input of the first group of analog inputs, and the second characteristic is associated with a second synaptic connection configured to deliver an input of the second group of analog inputs.

In a fifth aspect of the invention, neuronal network logic is disclosed. In one embodiment, the neuronal network logic comprises a series of computer program steps or instructions executed on a digital processor. In another embodiment, the logic comprises hardware logic (e.g., embodied in an ASIC or FPGA).

In a sixth aspect of the invention, a computer readable apparatus is disclosed. In one embodiment the apparatus comprises a storage medium having at least one computer program stored thereon. The program is configured to, when executed, implement learning in a mixed signal artificial neuronal network.

In a seventh aspect of the invention, a system is disclosed. In one embodiment, the system comprises an artificial neuronal (e.g., spiking) network having a plurality of “universal” nodes associated therewith, and a controlled apparatus (e.g., robotic or prosthetic apparatus).

In an eighth aspect of the invention, a universal node for use in a neural network is disclosed. In one embodiment, the node comprises a node capable of dynamically adjusting or learning with respect to heterogeneous (e.g., spiking and non-spiking) inputs.

Further features of the present invention, its nature and various advantages will be more apparent from the accompanying drawings and the following detailed description.

### BRIEF DESCRIPTION OF THE DRAWINGS

FIG. 1 is a block diagram illustrating a typical artificial neuron structure of prior art.

FIG. 1A is a plot illustrating input-output analog and spiking signal relationships according to prior art.

FIG. 2 is block diagram of an artificial neuron network comprising universal spiking neurons according to one embodiment if the invention.

FIG. 3A is a block diagram illustrating one embodiment of analog-to-spiking and spiking-to-analog signal conversion using a universal spiking node configured according to the invention.

FIG. 3B is a block diagram illustrating one embodiment of supervised learning by a universal node of a mixed signal network configured according to the invention.

FIG. 4 is a block diagram illustrating one embodiment of a mixed-signal artificial neural network comprising universal nodes configured according to the invention.

FIG. 5A presents data illustrating one embodiment of analog-to-analog signal conversion using supervised learning with the universal node of the embodiment shown in FIG. 3B. The panel 500 depicts selected node inputs, the panel 510 depicts the node analog signal output before learning in black and the target signal in gray; and the panel 520 depicts the node analog output after completion training in black and the target signal in gray.

FIG. 5B presents data illustrating output error measure corresponding to the data shown in FIG. 5A.

FIG. 6A presents data illustrating one embodiment of spiking-to-spiking signal conversing using supervised learning with the universal node of the embodiment shown in FIG. 3B receiving spiking input signals. The panel 600 depicts node spiking inputs; the panel 610 depicts node target and output spike trains before learning; and the panel 620 depicts the node target and output spike trains after completion training.

FIG. 6B presents data illustrating output error measure corresponding to the data shown in FIG. 6A.

FIG. 7A presents data illustrating one embodiment of analog-to-spiking signal conversion using supervised learning with the universal node of the embodiment shown in FIG. 3B that is receiving analog input signals. The panel 700 depicts selected analog inputs into the node; the panel 710 depicts node target and output spike trains before learning; and the panel 720 depicts the node target and output spike trains after completion training.

FIG. 7B presents data illustrating output signal error measure corresponding to the data shown in FIG. 7A.

FIG. 8A presents data illustrating one embodiment of spiking-to analog signal conversion using supervised learning with the universal node of the embodiment shown in FIG. 3B receiving spiking input signals. The panel 800 depicts node spiking inputs; the panel 810 depicts node analog signal output before learning in black and the target signal in gray; and the panel 820 depicts the node analog signal output after training in black and the target signal in gray.

FIG. 8B presents data illustrating output signal error corresponding to the data of embodiment shown in FIG. 8A.

All Figures disclosed herein are © Copyright 2011 Brain Corporation. All rights reserved.

### DETAILED DESCRIPTION OF THE EXEMPLARY EMBODIMENTS

Exemplary embodiments of the present invention will now be described in detail with reference to the drawings, which are provided as illustrative examples so as to enable those skilled in the art to practice the invention. Notably, the figures and examples provided herein are not meant to limit the scope of the present invention to a single embodiment, but other embodiments are possible by way of interchange of or combination with some or all of the described or illustrated elements. Wherever convenient, the same reference numbers will be used throughout the drawings to refer to the same or like parts.

Where certain elements of these embodiments can be partially or fully implemented using known components, only those portions of such known components that are necessary for an understanding of the present invention will be described, and detailed descriptions of other portions of such known components will be omitted so as not to obscure the invention.

In the present specification, an embodiment showing a singular component should not be considered limiting; rather, the invention is intended to encompass other embodiments including a plurality of the same component, and vice-versa, unless explicitly stated otherwise herein.

Further, the present invention encompasses present and future known equivalents to the components referred to herein by way of illustration.

As used herein, the terms “computer”, “computing device”, and “computerized device”, include, but are not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions and processing an incoming data signal.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “integrated circuit”, “chip”, and “IC” are meant to refer to an electronic circuit manufactured by the patterned diffusion of trace elements into the surface of a thin substrate of semiconductor material and generally include, without limitation, field programmable gate arrays (e.g., FPGAs), a programmable logic device (PLD), reconfigurable computer fabrics (RCFs), application-specific integrated circuits (ASICs).

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, field programmable gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the terms “node” and “neuronal node” refer, without limitation, to a network unit (such as, for example, a spiking neuron and a set of synapses configured to provide input signals to the neuron), a having parameters that are subject to adaptation in accordance with a model.

As used herein, the terms “state” and “node state” refer, without limitation, to a full (or partial) set of dynamic variables used to describe node state.

### Overview

In one aspect of the invention, apparatus and methods for universal node design directed implementing a universal learning rule in a neural network are disclosed. This approach advantageously allows, inter cilia, simultaneous processing of different input signal types (e.g., spiking and non-spiking, such as analog) by the nodes; generation of spiking and non-spiking signals by the node; and dynamic reconfiguration of universal nodes in response to changing input signal type and/or learning input at the node, not available to the existing spiking network solutions. The improvement is due to, in part, to the use a parameterized universal learning model configured to automatically adjust node model parameters responsive to the input types during training, and is especially useful in mixed signal (heterogeneous) neural network applications.

In one implementation, at one instance, the node apparatus, operable according to the parameterized universal learning model, receives a mixture of analog and spiking inputs, and generates a spiking output based on the node parameter that is selected by the parameterized model for that specific mix of inputs. At another instance, the same node receives a different mix of inputs, that also may comprise only analog or only spiking inputs) and generates an analog output based on a different value of the node parameter that is selected by the model for the second mix of inputs.

In another implementation, the node apparatus may change its output from analog to spiking responsive to a training input for the same inputs.

Thus, unlike traditional artificial neuronal networks, the universal spiking node of the present invention is configured to process a mixed set of inputs that may change over time, using the same parameterized model. This configuration advantageously facilitates training of the spiking neural network, and allows node reuse when the node representation of input and output signals (spiking vs. non-spiking signal representation) to the node changes.

In a broader sense, the invention provides methods and apparatus for implementing a universal learning mechanism that operates on different types of signals, including but not limited to firing rate (analog) and spiking signals.

### Detailed Description of Exemplary Embodiments

Detailed descriptions of the various aspects, embodiments and variants of the apparatus and methods of the invention are now provided.

The invention finds broad practical application. Embodiments of the invention may be, for example, deployed in a hardware and/or software implementation of a computer-controlled system, provided in one or more of a prosthetic device, robotic device and any other specialized apparatus. In one such implementation, a control system may include a processor embodied in an application specific integrated circuit (ASIC), a central processing unit (CPU), a graphics processing unit (GPU), a digital signal processor (DSP) or an application specific processor (ASP) or other general purpose multiprocessor, which can be adapted or configured for use in an embedded application such as controlling a robotic device. However, it will be appreciated that the invention is in no way limited to the foregoing applications and/or implementations.

Principles of the present invention may advantageously be applicable to various control applications (such as, for example, robot navigation controller; an automatic drone stabilization, robot arm control, etc.) that use a spiking neural network as the controller and comprise a set of sensors and actuators that produce signals of different types. Some sensors may communicate their state data using analog variables, whereas other sensors employ spiking signal representation.

By way of example, a set of such heterogeneous sensors may comprise, without limitation, the following:
an odometer that provides an analog signal being an estimate of a distance travel;
a laser range detectors providing information on a distance to obstacles, with the information being encoded using non-spiking (analog) signals;
a neuromorphic camera configured to encode visual information in sequences of spikes, see “In search of the artificial retina”, [online], Vision Systems Design, Apr. 1, 2007; and NIKOLIC, K., SAN SEGUNDO BELLO D., DELBRUCK, T, LIU, S., and ROSKA, B. “High-sensitivity silicon retina for robotics and prosthetics”, 2011;
an adjustable accelerometer configured to encodes slow varying motions using non-spiking (analog) signals and rapidly varying motions using spike timing signals;
an array of tactile sensors that encode touch information using timing of spiking.

Similarly, some of the actuators (e.g., electric DC motors, pneumatic or hydraulic cylinders, etc.) may be driven by analog signals, while other actuators may be driven by analog or spiking signals (e.g. stepper motors, and McKibben artificial muscles, described by Klute, G. K., Czemiecki, J. M., and Hannaford, B. (2002). Artificial Muscles: Actuators for Biorobotic Systems. The International Journal of Robotics Research 21:295-309, incorporated herein by reference in its entirety). In such heterogeneous system, the spiking controller may be required to integrate and concurrently process analog and spiking signals and similarly produce spiking and analog signals on its different outputs.

In some applications the encoding method may change dynamically depending on the additional factors, such as user input, a timing event, or an external trigger. In the example described supra, such a situation occurs when the sensors/motors operate in the different regimes such that, for example, in one region of the sensor/actuator operational state space a spiking signal representation is more appropriate for data encoding, whereas in another region of operation an analog signal encoding is more appropriate (e.g. as in the case of the accelerometer, as described above).

### Supervised Learning Methods

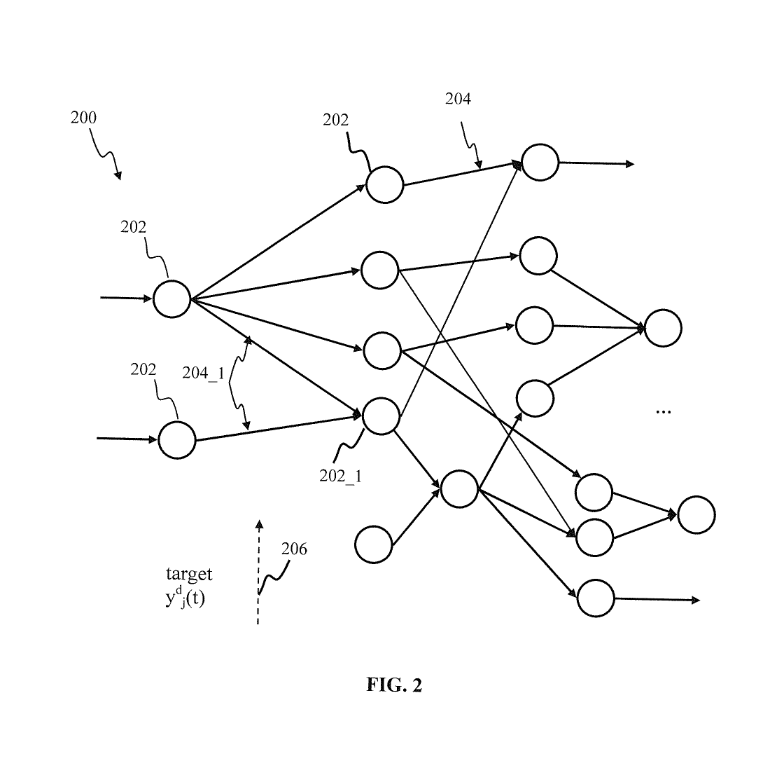

In one embodiment of the invention, a supervised learning method for an artificial neural network is described with reference to FIGS. 2-4. The network 200 shown in FIG. 2 is comprised of spiking neurons 202, which are operated according to a spiked model described, for example, by the Eqn. 4 (see also Gerstner W. and Kistler W., 2002, incorporated supra). The neurons 202 are interconnected by a plurality of synaptic connections 204 that are characterized by one or more synaptic variables, such as connection strength (weight) or delay. Different synaptic connections (e.g., connections 204_1 in FIG. 2) provide input signals to a particular neuron 202_1. A target signal {yⱼ^{d}} is provided to the network 200 in order to facilitate training. The training method objectives comprise adjustment and modification of neuronal state(s) and/or synaptic parameters in order to achieve a desired output for the particular given input signals.

In some embodiments, the node state adjustment may include, for example, a firing threshold adjustment, output signal generation, node susceptibility or excitability modifications according to a variety of methods, such as for example those described in co-owned and co-pending U.S. patent application Ser. No. 13/152,105 filed on Jun. 2, 2011, and entitled “APPARATUS AND METHODS FOR TEMPORALLY PROXIMATE OBJECT RECOGNITION”, incorporated herein by reference in its entirety.

The neuronal time constant τₙ=RC, where R is the input resistance and C is the membrane capacitance as defined in Eqn. 4. The firing threshold u is a parameter that controls output signal generation (firing) of a neuron. In a deterministic neuron, the neuron generates output (i.e., fires a spike) whenever the neuronal state variable u(t) exceeds the threshold υ. In a stochastic neuron, firing probability is described by a probabilistic function prob of (υ−u(t)), e.g. prob(υ−u(t))=exp(u(t)−υ), where u(t)<υ. After the stochastic neuron generates an output, the state variable u(t) is reset to a predetermined reset value uᵣₑₛₑₜ(t)<υ. In one implementation, the neuron state variable u(t) is held at the reset level for a period of time t_{refr}, referred to as the refractory period. In absence of any subsequent inputs to the neuron, the neuron state settles at the resting potential uᵣₑₛ(t). For more details on this exemplary process, see Gerstner W. and Kistler W. (2002), incorporated supra.

In some embodiments of the invention, the synaptic connection adjustment includes modification of synaptic weights, and/or synaptic delays according to a variety of applicable synaptic rules, such as for example those described in and co-owned and co-pending U.S. patent application Ser. No. 13/239,255 filed on Sep. 21, 2011, and entitled “APPARATUS AND METHODS FOR SYNAPTIC UPDATE IN A PULSE-CODED NETWORK”, incorporated herein by reference in its entirety.

In one approach, a synapse (e.g., the synapse 204 in FIG. 2) is modeled as a low-pass filter that delivers an input signal (the synaptic response i(t)) into post-synaptic neuron in response to receiving input spikes S(t), as described by Eqn. 5. The synaptic time constant of the filter corresponds to the parameter τₛ in Eqn. 5. The synapse is characterized by a synaptic delay d that defines a delay between the inputs spikes and the synaptic response i(t) using, in one variant, the relationship of S(t-d) for relating the input to the synapse.

In some embodiments, transmission of spikes by synapses is described using a deterministic model so that every input spike generates a synaptic response i(t). The transmission of spikes by synapses can be described e.g., using a stochastic approach, where some synaptic inputs fail to generate synaptic responses. Stochastic synapse is modeled, in one variant, using a probabilistic function P(s) so that probability of generation of a synaptic response to the f-th spike in S(t) is equal to a certain value p, e.g., p=0.5. See Gerstner W. and Kistler W. (2002) for further description of exemplary synaptic models and synaptic parameters useful with the present invention.

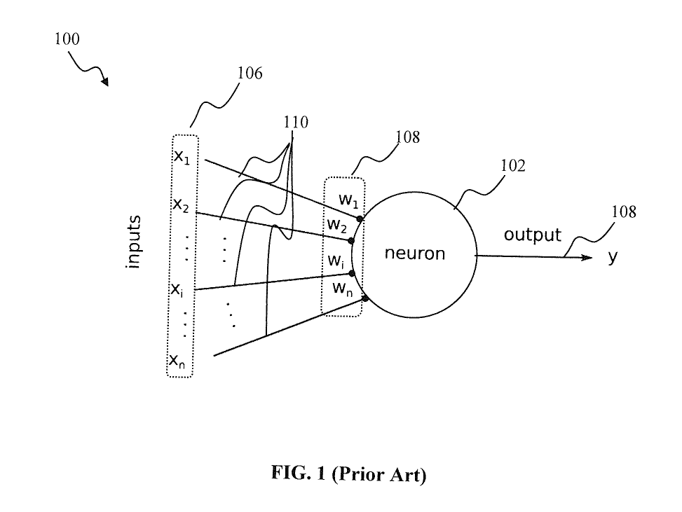

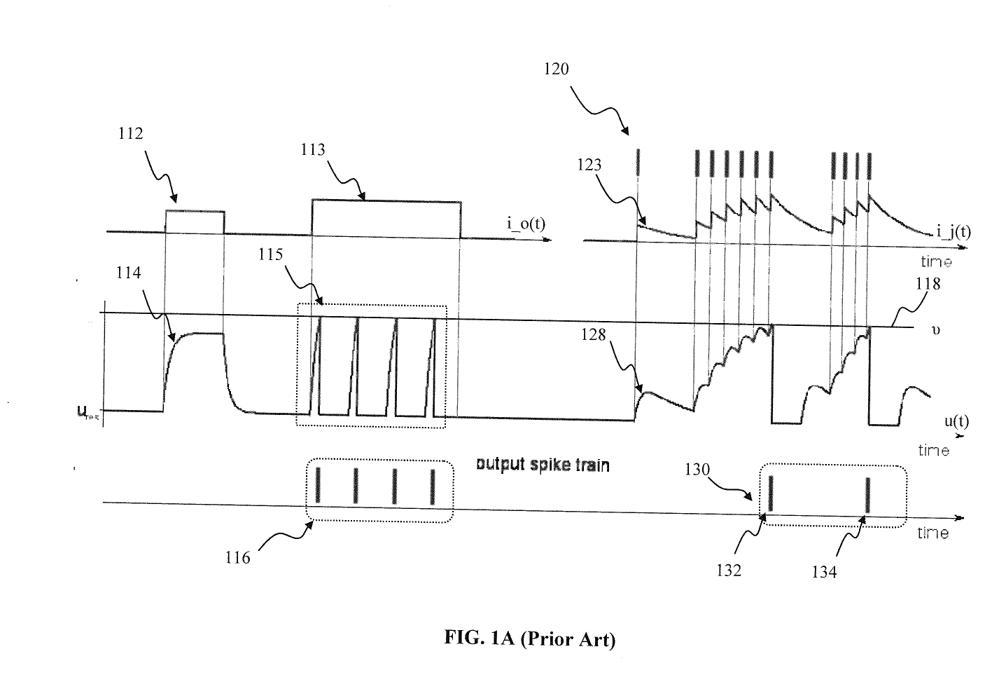

Typically, input signals carried by the synaptic connections 204 comprise any of analog and/or spiking signal, as illustrated in FIG. 1A supra. The trace 112 in FIG. 1A represents an analog input into a node, while the second trace 120 illustrates spiking input into the node.

As described previously herein, the delta learning rule according to Eqn. 6 is used in order to obtain node output in response to node inputs when both the inputs and the outputs comprise analog signal types, such as for example, an instantaneous firing rate of the spiking neurons. Similarly, the ReSuMe learning rule according to Eqn. 7 is used in order to obtain node spiking output for a spike train input (such as the input 220 in FIG. 213) into the node. However, neither the model of Eqn. 6 nor the model of Eqn. 7 is capable of describing mixed input/output signal node operation.

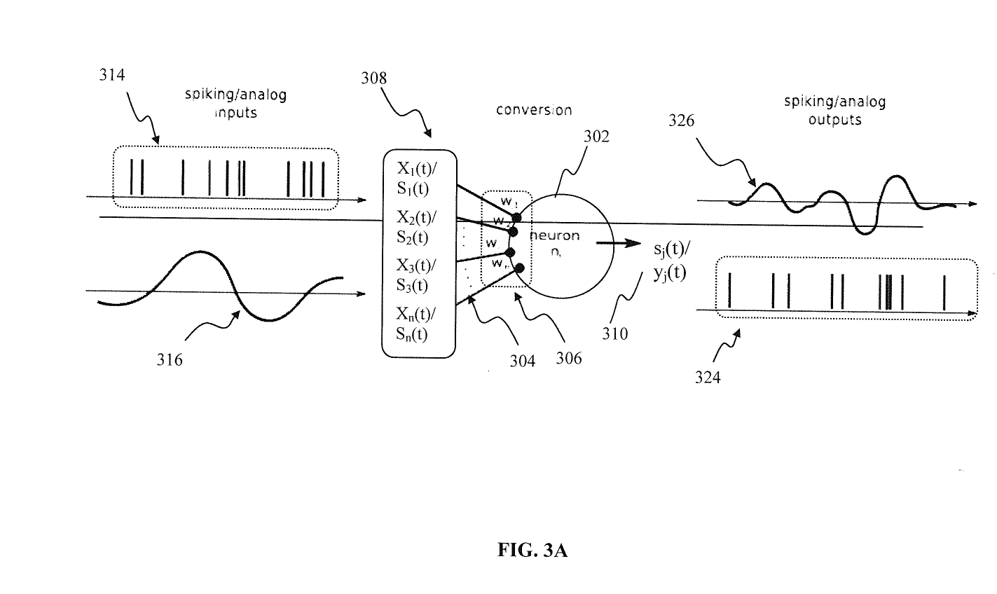

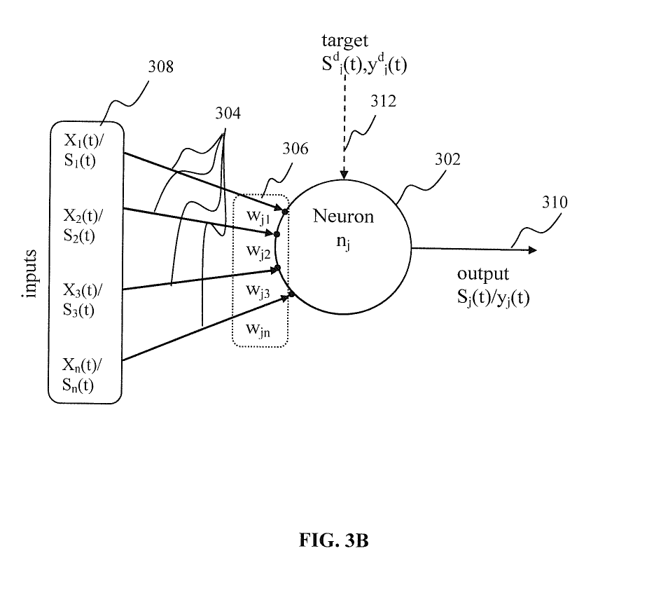

Referring now to FIG. 3A, one embodiment of a universal mixed signal node operable according to a unified learning rule, that is configured to operate with both analog and the spiking signals, is described in detail. The mixed signal node 302 receives inputs 308 via synaptic connections 304, and generates outputs 310. The synaptic connections 304 are characterized by synaptic variables w that are modified during learning. The inputs 308 may comprise any combination of analog 314 and/or spiking 316 signals. The output 310 may be either of analog type or the spiking type (shown by the traces 326, 324, respectively, in FIG. 3A).

In one embodiment, illustrated in detail in FIG. 3B, the universal node 302 further receives a training signal (denoted by the target signal y^{d}ⱼ(t) 312) that describes the desired output for the j^{th} node.

The universal learning rule of the node 302 is, in one embodiment, described as follows:

\dot{w}ⱼᵢ(t)=ρ( S̅ⱼ̅^̅{̅d̅}̅ (t)− S̅ⱼ(t)) S̅ᵢ(t), (10)

where:
wⱼᵢ(t)—the efficacy of the synaptic connection from the pre-synaptic neuron i to neuron j;
\dot{w}ⱼᵢ(t) is the derivative of wⱼᵢ(t) over time;
ρ—is the constant defining the learning rate;
S̅ⱼ̅^̅{̅d̅}̅ (t)—is the low-pass filtered version of the target spike train for neuron j, with a filter time constant τ^{d}ⱼ;
S̅ⱼ(t)—is the low-pass filtered version of the output spike train from neuron j, with a filter time constant τⱼ; and
S̅ᵢ(t)—is the low-pass filtered version of the i-th input spike train to neuron j, with a filter time constant τᵢ.

The learning rule given by Eqn. 10 is applicable to both online and batch learning, and the learning rule signal regime (i.e., analog vs. spiking) is determined by changing just one parameter (or a defined parameter set) as described below. The signals S̅ⱼ̅^̅{̅d̅}̅ (t), S̅ⱼ(t) and S̅ᵢ(t) in Eqn. 10 represent the low-pass filtered versions of the target, output, and input spike trains, respectively. In general, however, S̅ⱼ̅^̅{̅d̅}̅ (t), S̅ⱼ(t) and S̅ᵢ(t) may be any arbitrary parameterized function F(S) of the respective spike trains, selected such that the function parameters change the function output representation to use either (i) the spiking representation; (ii) the analog signal representation; or (iii) a mixture of both representations. Several exemplary eases of the universal node learning rules are described in detail below.

### Case 1: Learning in the Spike-Timing (Spiking Inputs/Spiking Outputs)

The ReSuMe rule (Eqn. 7) can be approximated by using the rule of Eqn. 10 in the limit of τⱼ→0, τ^{d}ⱼ→0 and with τᵢ equal to the corresponding time constant of the i-th input signal in Eqn. 6. In such a case S̅ᵢ(t)=Sⱼ(t), S̅ⱼ̅^̅{̅d̅}̅ (t)=Sⱼ^{d}(t), so the learning rule of Eqn. 10 takes the following form:

\dot{w}ⱼᵢ(t)=η(Sⱼ^{d}(t)−Sⱼ(t)) S̅ᵢ(t), (10.a)

which is identical to the ReSuMe rule given by Eqn. 7, supra. The learning rule of Eqn. 10.a is used to effect learning for a subset of the input signals reproduce target signals encoded in precise spike timing.

### Case 2: Learning in the Firing-Rate Domain (Analog Inputs, Analog Outputs)

The delta rule (Eqn. 6) can be approximated by the rule of Eqn. 10 in the limit where the time constants τⱼ, τ^{d}ⱼ, τᵢ are long enough, such that the signals S̅ⱼ(t), S̅ⱼ̅^̅{̅d̅}̅ (t) and S̅ᵢ(t) approximate firing rate of the corresponding spike trains, that is S̅ⱼ(t)≅(xⱼ(t)), S̅ⱼ̅^̅{̅d̅}̅ (t)≅(yⱼ^{d}(t)), S̅ᵢ(t)≅(xᵢ(t)). In this case, the learning rule of Eqn. 10 takes the form:

\dot{w}ⱼᵢ(t)=η((yⱼ^{d}(t)−(xⱼ(t)))(xᵢ(t)), (10.b)

In Eqn. 10.b the signals (xⱼ(t)), (yⱼ^{d}(t)), (y(t)) are considered as represented by floating-point values, and accordingly Eqn. 10.b. represents a learning rule equivalent to the delta rule of Eqn. 7, described supra.

### Case 3: Spiking Inputs, Analog Outputs

The time constants τⱼ, τ^{d}ⱼ, τᵢ can also be set up such that the spike-based and rate-based (analog) encoding methods are combined by a single universal neuron, e.g., the neuron 302 of FIG. 3A. By way of example, when τⱼ, τ^{d}ⱼ are long, such that S̅ⱼ(t)≅(yⱼ(t)), S̅ⱼ̅^̅{̅d̅}̅ (t)≅(yⱼ^{d}(t)), and τᵢ→0, the learning rule of Eqn. 10 takes the following form:

\dot{w}ⱼᵢ(t)=η((y^{d}(t))−(yⱼ(t)))Sᵢ(t) (10.e)

which is appropriate for learning in configurations where the input signals to the neuron 302 are encoded using precise spike-timing, and whereas the target signal y^{d}ⱼ and output signals yⱼ use the firing-rate-based encoding. In one variant, the analog output signals yⱼ are represented using the floating-point computer format, although other types of representations appreciated by those of ordinary skill given the present disclosure may be used consistent with the invention as well.

### Case 4: Analog Inputs, Spiking Outputs

In yet another case, applicable to firing rate based (analog) inputs and spiking outputs, the time constants τⱼ, τ^{d}ⱼ corresponding to the analog inputs are infinitesimal (i.e. τⱼ→0, τ^{d}ⱼ→0), such that S̅ⱼ(t)=Sⱼ(t), S̅ⱼ̅^̅{̅d̅}̅ (t)=Sⱼ^{d}(t). The time constant τᵢ is much larger than τⱼ, τ^{d}ⱼ such that S̅ᵢ(t)≅(xᵢ(t)). Accordingly, the learning rule of Eqn. 10 takes the following form:

\dot{w}ⱼᵢ(t)=η(Sⱼ^{d}(t)−Sⱼ(t))(xᵢ(t)), (10.d)

which is appropriate for training of neurons receiving signals encoded in the neural firing rate and producing signals encoded in precise spike timing.

Other combinations of the spike-based and firing-based encoding within a single trained neuron are also possible. In one embodiment, by setting the time constants τᵢ individually for each synaptic input 304, some inputs 304 become configured to respond to precise spike timing signals, while other inputs become configured to respond only to the firing rate signals.

During learning, model and node network parameter updates may be effected, in one implementation, upon receiving and processing a particular input by the node and prior to receipt of a subsequent input. This update mode is commonly referred to as the online-learning. In another implementation, parameter updates are computed, buffered, and implemented at once in accordance with an event. In one variant, such event corresponds to a trigger generated upon receipt of a particular number (a pre-selected or dynamically configured) of inputs. In another variant, the event is generated by a timer. In another variant, the event is generated externally. Such mode of network operation is commonly referred to as the batch learning.

### Generalized Learning Method

In one embodiment of the invention, the learning method described by Eqn. 10 is generalized to apply to an arbitrary synaptic learning rule as follows:

\dot{w}ⱼᵢ(t)=ζ( S̅₁(t), . . . , S̅ₖ̅ (t)), (11)

where:
ζ( ) is a function defined over a set of k input signals;
k is an integer; and
the parameterized functions ( S̅₁(t), . . . , S̅ₖ̅ (t)) denote the input signals.

The parameterized functions ( S̅₁(t), . . . , S̅ₖ̅ (t)) are defined such that in two extreme cases they approximate either the spiking inputs or the analog inputs (e.g. corresponding to the instantaneous neural firing rate) depending on the parameter value of functions. In one embodiment, the function comprises a low pass filter, and the parameter comprises the time constant τ of the filter. In one variant, the filter is given by Eqn. 8. In another variant it comprises an exponential filter kernel defined by Eqn. 9.

The approach described by Eqn. 11 provides a learning continuity for the input signals comprising both the analog and the spiking inputs and for the input signals that change their representation from one type (e.g., analog or spiking) to another in time.

As in the specific case of the embodiment presented above (as discussed for the rule of Eqn. 10), the general approach also permits training of neural networks that combine different representations of signals processed within networks.

A neural network trained according to the exemplary embodiment of the invention is capable of, inter alia, processing mixed sets of inputs that may change their representation (e.g., from analog to spiking and vice versa) over time, using the same neuron model. The exemplary embodiments of the invention advantageously allow a single node to receive input signals, wherein some sets of inputs to the node carry information encoded in spike timing, while other sets of inputs carry information encoded using analog representation (e.g., firing rate).

The exemplary embodiment of the invention further advantageously facilitates training of the spiking neural network, and allows the same nodes to learn processing of different signal types thereby facilitating node reuse and simplifying network architecture and operation. By using the same nodes for different signal inputs, a requirement for duplicate node populations and duplicate control paths (e.g., one for the analog and one for the spiking signals) is removed and a single population of universal nodes may be adjusted in real time to dynamically changing inputs and outputs. These advantages may be traded for a reduced network complexity, size and cost, or increased network throughput for the same network size.

### Reinforcement Learning Methods

In reinforcement learning, the input data x(t) are usually not available, but are generated via an interaction between a learning agent and the environment. At each point in time t, the agent performs an action y_t and the environment generates an observation x_t and an instantaneous cost c_t, according to some (usually unknown) dynamics. The aim of the reinforcement learning is to discover a policy for selecting actions that minimizes some measure of a long-term cost; i.e., the expected cumulative cost. The environment's dynamics and the long-term cost for each policy are usually unknown, but can be estimated.

In one implementation, training of neural network using reinforcement learning approach is used to control an apparatus (e.g., a robotic device) in order to achieve a predefined goal, such as for example to find a shortest pathway in a maze. This is predicated on the assumption or condition that there is an evaluation function that quantifies control attempts made by the network in terms of the cost function. Reinforcement learning methods like those described in detail in U.S. patent application Ser. No. 13/238,932 filed Sep. 21, 2011, and entitled “ADAPTIVE CRITIC APPARATUS AND METHODS”, incorporated supra, can be used to minimize the cost and hence to solve the control task, although it will be appreciated that other methods may be used consistent with the invention as well.

In general, reinforcement learning is typically used in applications such as control problems, games and other sequential decision making tasks, although such learning is in no way limited to the foregoing.

### Unsupervised Learning Methods

In some embodiments, the principles of the invention are applied to unsupervised learning. In machine learning, unsupervised learning refers to the problem of finding hidden structure in unlabeled data. Since the examples given to the learner are unlabeled, there is no error or reward signal to evaluate a potential solution. Two very simple classic examples of unsupervised learning are (i) clustering, and (ii) dimensionality reduction. Other tasks where unsupervised learning is used may include without limitation) clustering, estimation of statistical distributions, data compression and filtering.

A detailed discussion and examples of unsupervised learning rules for artificial neural networks are provided in Haykin (1999) Neural Networks: A Comprehensive Foundation, Prentice Hall, incorporated herein by reference in its entirety.

### Signal Conversion Apparatus

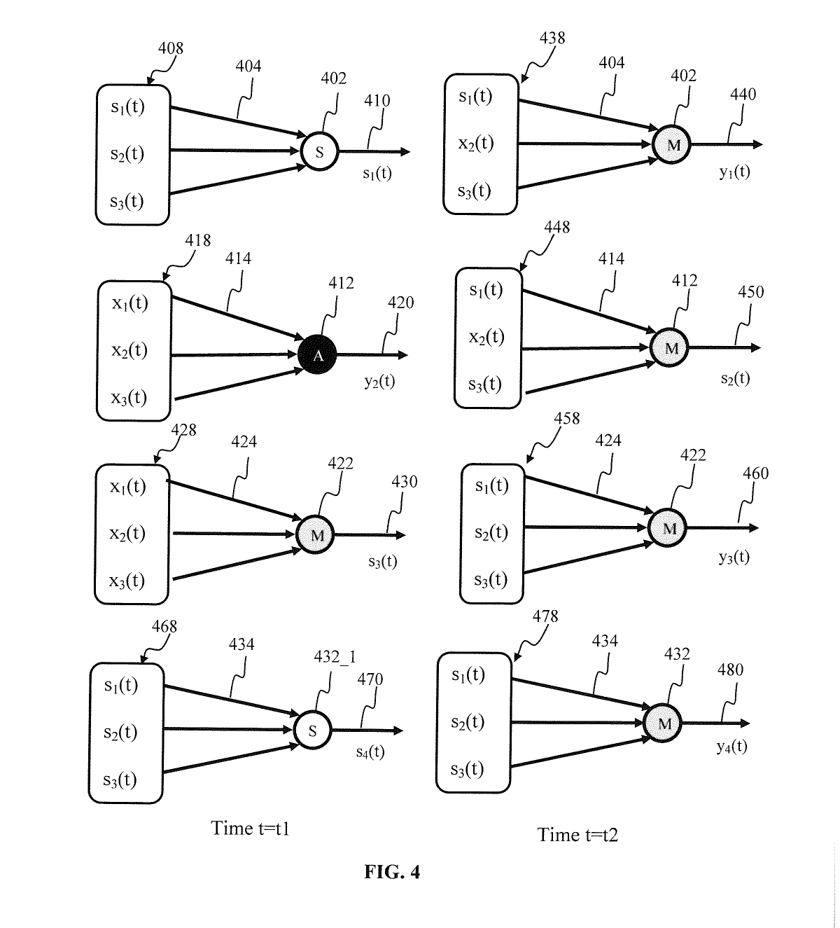

Referring now to FIG. 4, an exemplary embodiment of a signal conversion approach using the universal nodes (e.g., the node 302 of FIG. 3A) and the universal learning rule of Eqn. 10 and 11 are shown and described in detail. At time t1, the node 402 receives a group of spiking inputs 408 via the connections 404 ant it produces spiking output sᵢ(t) 410; the node 412 receives a group of analog inputs 418 via the connections 414 and it produces analog output y₂(t) 420. The node 422 receives a group of analog inputs 428 via the connections 424, and it produces spiking output s₃(t) 430, and the node 432 receives a group of spiking inputs 468 via the connections 434, and it produces spiking output s₄(t) 470. The nodes depicted by black circles containing the letter ‘A’ denote nodes operating according to fully analog regime, with all of the inputs and outputs being represented as analog signals. The nodes depicted by white circles containing the letter ‘S’ denote nodes operating according to fully spiking regime, with all of the inputs and outputs being represented as spiking signals. The nodes depicted by shaded circles and containing the letter denote nodes operating according to a mixed signal regime, with a mix of analog/spiking inputs and outputs.

At time t2, (i) the node 402 receives a group of mixed inputs 438 via the connections 404, and it produces analog output yᵢ(t) 440; (ii) the node 412 receives a group of mixed inputs 448 via the connections 414 and it produces spiking output s₂(t) 450; (iii) the node 422 receives a group of spiking inputs 458 via the connections 424, and it produces analog output y₃(t) 460; and (iv) the node 432 receives a group of spiking inputs 478 via the connections 434 and it produces analog output y₄(t) 480.

It is seen from FIG. 4 that the same node (e.g., the node 422) is configured to receive the analog inputs at one time (e.g., the time t1), and to generate the spiking output; and to receive the spiking inputs at another time (e.g., the time t2), and to generate the analog output. A different node (e.g., the node 432 in FIG. 4) is configured to generate the spiking output 470 at time ti and the analog output 480 at time t2, when receiving only spiking inputs 468, 478, respectively. Furthermore, nodes (e.g., the node 402, 412) that receive mixed inputs 438, 448, respectively, may generate analog 440 or spiking 450 outputs. The learning method of Eqn. 10 and Eqn. 11 applied to the nodes illustrated in FIG. 4 advantageously allow the same nodes to learn processing of different signal types, thereby both facilitating node reuse and simplifying network architecture and operation. By using the same nodes for different signal inputs, a requirement for duplicate node populations and duplicate control paths (e.g., one for the analog and one for the spiking signals) is removed, and a single population of universal nodes may be adjusted in real time to dynamically changing inputs and outputs. These advantages may be traded for a reduced network complexity, size and cost for the same capacity, or increased network throughput for the same network size.

### Performance:

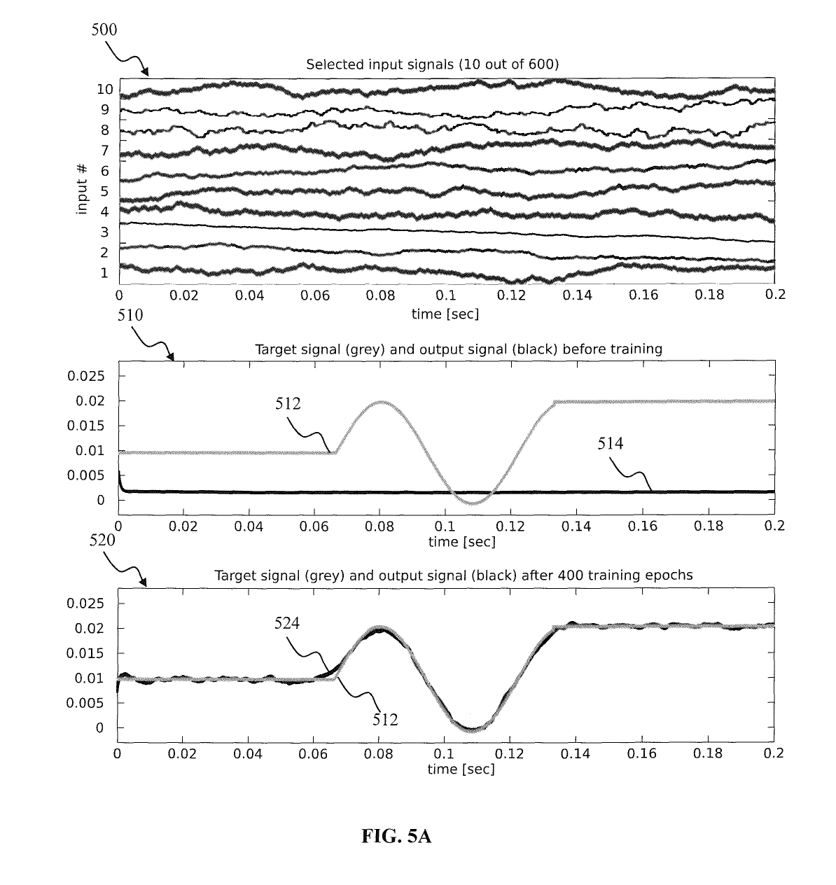

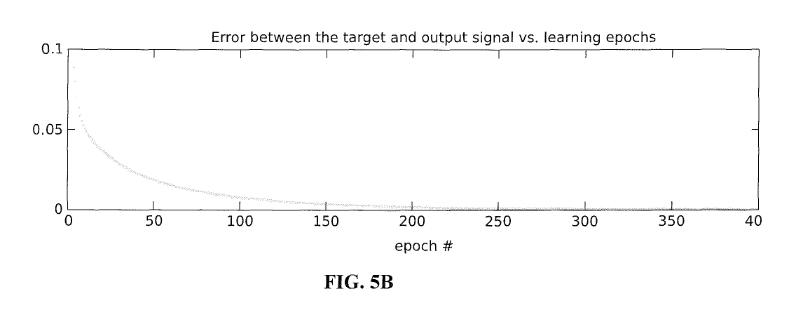

FIGS. 5A through 8B present performance results obtained during simulation by the Assignee hereof using a single “universal” neuron operated according to a learning rule that is described, in one embodiment of the invention, by to Eqn. 10 (and the exemplary Cases 1 through 4 described supra). The exemplary neuron, used in the simulations described below, is modeled using a leaky integrate-and-fire neuron model, described by Eqn. 4 supra, and is configured similar to the node 302 of the embodiment of FIG. 3B. The node 302 receives analog S̅ᵢ(t)=xᵢ(t) inputs and/or spiking S̅ᵢ(t)=Sᵢ(t) inputs via synaptic channels 304, and an analog S̅ⱼ̅^̅{̅d̅}̅ (t)=yⱼ^{d}(t) target signal or spiking S̅ⱼ̅^̅{̅d̅}̅ (t)=Sⱼ^{d}(t) target signal. Based on these inputs and the learning rule configuration, the node 302 generates a single analog S̅ⱼ(t)=xⱼ(t) and/or spiking S̅ⱼ(t)=Sⱼ(t) output 310. The input and target signal in all simulations are generated randomly, although other generation schemes may conceivably be applied (e.g., according to a probabilistic model or designated function). In order to generate the spiking signals in this simulation, a homogeneous Poisson process with rate 100 Hz is used for spike train generation. In order to generate the analog input signals, a random walk model is used. In all simulations, synaptic strengths of the connections are initialized randomly according to a Gaussian distribution and all synaptic inputs are assumed excitatory. An online learning rule given by Eqn. 10 is used for synaptic updates in all simulations. By way of illustration, a term ‘a learning epoch’ is used to denote a single presentation of the input vector xᵢ(t) and the target signal to the neuron under training.

In order to quantitatively evaluate the performance of learning, two distance measures are used. For analog signal outputs, the mean square error (MSE) between the target and output vectors is computed.

For spiking signal outputs, a correlation-based measure C, which expresses a distance between spikes of the spike train spikes of the node output pulse train. See Schreiber S. et al. (2003), “A new correlation-based measure of spike timing reliability”. Neurocomputing, 52-54, 925-931, incorporated herein by reference in its entirety, although other approaches may be used with equal success. For all uncorrelated spike trains, the error measure C is set to be equal to zero. For perfectly matched spike trains, the error measure C is equal to unity (1).

FIGS. 5A-5B present data related to simulation results for the neuron trained using analog input signals {Xᵢ}, and configured to generate an analog output signal y(t) that matches the target analog signal y^{d}(t) using the learning rule Eqn. 10 (in the configuration given by Eqn. 10.b herein). The plate 500 in FIG. 5A shows 10 of 600 analog inputs, depicted by individual lines selected at random. In the plates 510, 520, the traces 512 depict the analog target signal y^{d}(t), and the traces 514, 524 show the node output before and after training, respectively. The data in the plate 520 of FIG. 5A represent a single epoch snapshot of the node input/output signal dynamics taken after 400 training epochs, and advantageously show a very high level of agreement between the target and the output signals, in contrast to the output data prior to training shown in the plate 510 of FIG. 5A.

FIG. 5B shows the MSE error measure between the trained node output y(t) (e.g., the data corresponding to the trace 524 in the plate 520 of FIG. 5) and the target signal y^{d}(t) as a function of the learning epoch. As shown by the data in FIG. 5B, the error rapidly decreases and becomes very small after the epoch #300.

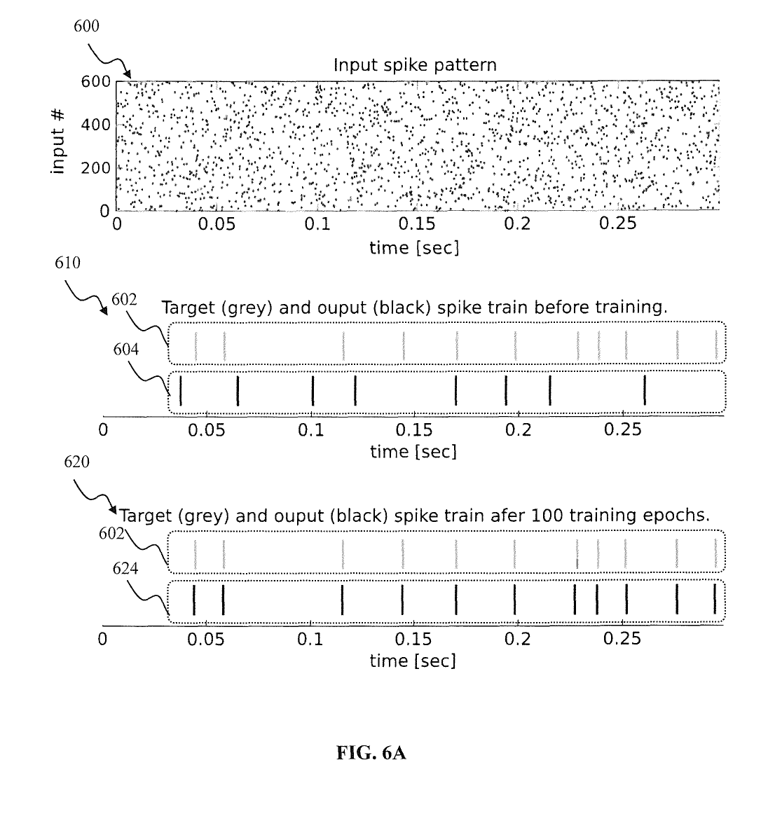

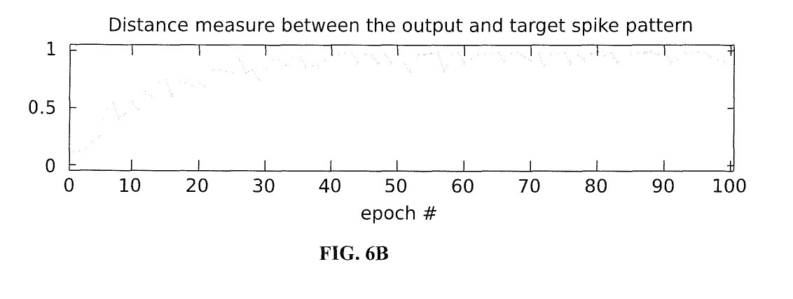

FIGS. 6A-6B present data related to simulation results for the neuron trained using spiking input signals Sᵢ(t), and configured to generate a spiking output signal Sⱼ(t) that matches the target spiking signal Sⱼ^{d}(t) using the learning rule Eqn. 10 in the configuration given by Eqn. 10.a. The plate 600 in FIG. 6A, shows all 100 of the spiking inputs. The dots in the plate 610 correspond to the firing times of the particular spikes in the particular input signals. In the plates 610, 620, the spike trains 602 depict the spiking target signal Sⱼ^{d}(t), and the spike trains 604, 624 show the node output before and after training, respectively. The target and the output spike trains are visualized by the light and dark vertical bars, respectively, plotted at the target or output firing times. The data in the plate 620 of FIG. 6A represent a single epoch snapshot of the node input/output signal dynamics taken after 100 training epochs, and show a very high level of agreement between the target and the output spike trains, in contrast to the output data prior to training shown in the plate 610 of FIG. 6A.

FIG. 6B shows the correlation error measure C between the trained node output Sⱼ(t) (e.g., the data corresponding to the trace 624 in the plate 620 of FIG. 6) and the target signal Sⱼ^{d}(t) as a function of the learning epoch. As shown by the data in FIG. 6B, the error rapidly decreases and becomes very small after the epoch #50.

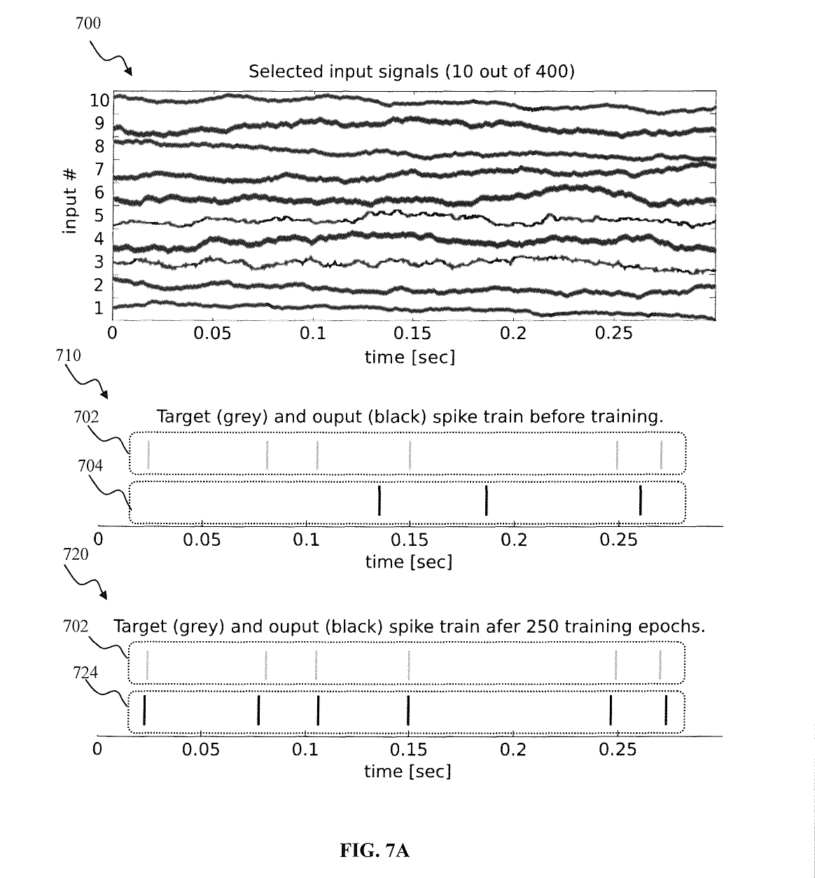

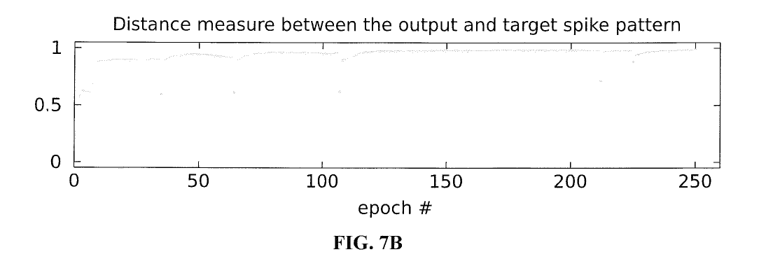

FIGS. 7A-7B present data related to simulation results for the neuron trained using analog input signals xᵢ(t), and configured to generate a spiking output signal S_{f}(t) that matches the target spiking signal Sⱼ^{d}(t) using the learning rule Eqn. 10 in the configuration given by Eqn. 10.d. The plate 700 in FIG. 7A, shows 10 of 400 analog inputs depicted by individual lines selected at random. In the plates 710, 720, the spike trains 702 depict the spiking target signal Sⱼ^{d}(t) (0, and the spike trains 704, 724 show the node output before and after training, respectively. The target and the output spike trains are visualized by the light and dark vertical bars, respectively, plotted at the target or output firing times. The data in the plate 720 of FIG. 7A represent a single epoch snapshot of the node input/output signal dynamics taken after 250 training epochs, and show a very high level of agreement between the target and the output signals, as illustrated by the spike trains 702, 724 in the plate 720 of FIG. 7A, in contrast to the output data prior to training shown in the plate 710 of FIG. 7A.

FIG. 7B shows the correlation error measure C between the trained node output Sⱼ(t) (e.g., the data corresponding to the trace 724 in the plate 720 of FIG. 7) and the target signal Sⱼ^{d}(t) as a function of the learning epoch. As shown by the data in FIG. 7B, the error rapidly decreases and becomes very small after the epoch #100.

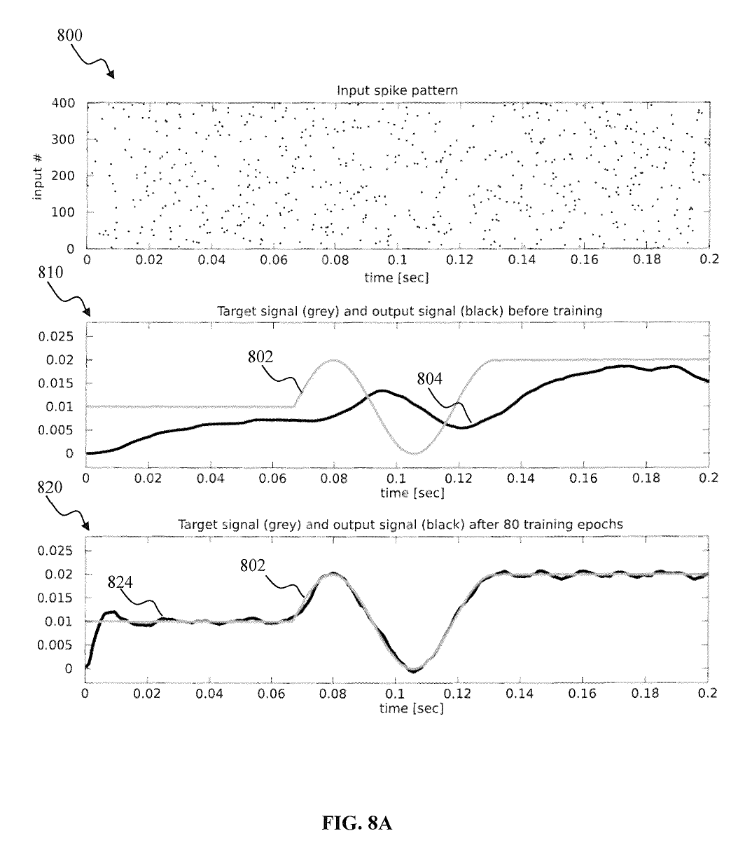

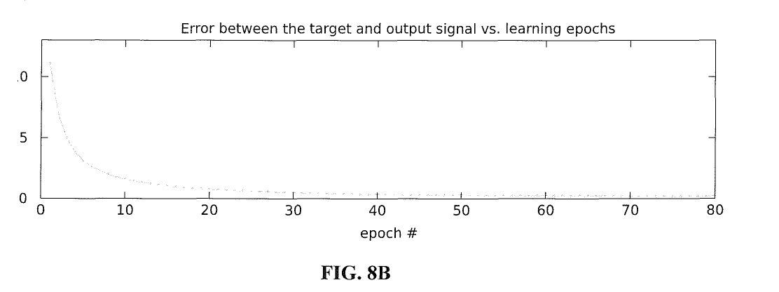

FIGS. 8A-8B present data related to simulation results for the neuron trained using spiking input signals Sᵢ(t), and configured to generate an output signal y(t) that matches the target analog signal y^{d}(t) using the learning rule Eqn. 10 in the configuration given by Eqn. 10.c. The plate 800 in FIG. 8A, shows all 600 spiking inputs. The dots in the plate 810 correspond to the firing times of the particular spikes in the particular input signals. In the plates 810, 820, the traces 802 depict the analog target signal y^{d} (t), and the traces 804, 824 show the node analog output signal before and after training, respectively. The data in the plate 820 of FIG. 8A represent a single epoch snapshot of the node input/output signal dynamics taken after 80 training epochs and show a very high level of agreement between the target and the output signals, as illustrated by the traces 802, 824 in the plate 820 of FIG. 8A, in contrast to the output data prior to training shown in the plate 810 of FIG. 8A.

FIG. 8B shows the MSE error measure between the trained node output y(t) (e.g., the data corresponding to the trace 824 in the plate 820 of FIG. 8B and the target signal y^{d}(t) as a function of the learning epoch. As shown by the data in FIG. 8B, the error rapidly decreases and becomes very small after the epoch #60.

Summarizing, the exemplary simulation data presented in FIGS. 5A-8B confirm that after training in accordance with one embodiment of the invention, the analog target and analog output signals closely overlap. For spiking signals, extraneous or missing spikes, observed initially, are removed or added, respectively, as the node training progresses and the spike times gradually become more consistent with the firing times of the target spikes.

The error measure data presented in FIGS. 5B, 6B, 7B, 8B further illustrate that for every considered learning scenario, the error measure quickly approaches zero (for the analog inputs) or one (for the spiking inputs), which indicates fast learning convergence and a close match of the output signal with the target signals. The above results also demonstrate that the learning methods and apparatus of the exemplary embodiments of the invention conveniently allow for configuration of the neural network to provide the desired signal processing properties that are appropriate for processing either of the analog and spiking signals, or a mixture of both.

### Exemplary Uses and Applications of Certain Aspects of the Invention

Apparatus and methods implementing universal learning rules of the invention advantageously allow for an improved network architecture and performance. Unlike traditional artificial neuronal networks, the universal spiking node/network of the present invention is configured to process a mixed set of inputs that may change their representation (from analog to spiking, and vice versa) over time, using the same parameterized model. This configuration advantageously facilitates training of the spiking neural network, allows the same nodes to learn processing of different signal types, thereby facilitating node reuse and simplifying network architecture and operation. By using the same nodes for different signal inputs, a requirement for duplicate node populations and duplicate control paths (e.g., one for the analog and one for the spiking signals) is removed, and a single population of universal nodes may be adjusted in real time to dynamically changing inputs and outputs. These advantages may be traded for a reduced network complexity, size and cost for the same capacity, or increased network throughput for the same network size.

In one embodiment, the universal spiking network is implemented as a software library configured to be executed by a computerized spiking network apparatus (e.g., containing a digital processor). In another embodiment, the universal node comprises a specialized hardware module (e.g., an embedded processor or controller). In another embodiment the spiking network apparatus is implemented in a specialized or general purpose integrated circuit, such as, for example ASIC, FPGA, or PLD). Myriad other implementations exist that will be recognized by those of ordinary skill given the present disclosure.

Advantageously, the present invention can be used to simplify and improve control tasks for a wide assortment of control applications including without limitation industrial control, navigation of autonomous vehicles, and robotics. Exemplary embodiments of the present invention are useful in a variety of devices including without limitation prosthetic devices (such as artificial limbs), industrial control, autonomous and robotic apparatus, HVAC, and other electromechanical devices requiring accurate stabilization, set-point control, trajectory tracking functionality or other types of control. Examples of such robotic devices include manufacturing robots (e.g., automotive), military devices, and medical devices (e.g. for surgical robots). Examples of autonomous vehicles include rovers (e.g., for extraterrestrial exploration), unmanned air vehicles, underwater vehicles, smart appliances (e.g. ROOMBA®), etc. The present invention can advantageously be used also in all other applications of artificial neural networks, including: machine vision, pattern detection and pattern recognition, signal filtering, data segmentation, data compression, data mining, optimization and scheduling, or complex mapping.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed:

1. A method of operating a node in a computerized neural network, the method comprising:
Combining, at said node, at least one spiking input signal and at least one analog input signal using a parameterized rule configured to effect output generation by the node;
based at least in part on said at least one spiking signal and said at least one analog signal, modifying a parameter of said parameterized rule; and
generating an output signal by said node, based at least in part on said rule having said modified parameter.

2. The method of claim 1, wherein:
said parameter is associated with said node;
said node comprises a spiking neuron and a set of synapses configured to provide input signals to said neuron; and
said neuron and said set of synapses are operated, at least in part, according to said parameterized rule.

3. The method of claim 1, wherein said output is encoded using spiking representation.

4. The method of claim 1, wherein said output is encoded using analog representation.

5. The method of claim 1, wherein said parameterized rule comprises a parameterized function of said parameter.

6. The method of claim 1, wherein said parameterized rule comprises a plurality of computer executable instructions.

7. The method of claim 1, wherein:
said parameterized rule comprises a supervised learning rule; and
said modifying said parameter is configured based at least in part on a target signal, the target signal being representative of a desired node output.

8. The method of claim 7, wherein:
said supervised learning rule comprises an off-line; and
said modifying said parameter is delayed until a predetermined set of input signals having been presented to the node, the predetermined set comprising said at least one spiking input signal and said at least one analog input signal.

9. The method of claim 7, wherein:
said supervised learning rule comprises an online method; and
said modifying said parameter is effected prior a predetermined set of input signals having been presented to the node, the predetermined set comprising said at least one spiking input signal and said at least one analog input signal.

10. A computer implemented method of operating a neural network, the method comprising:
processing, at a node of said network, at least one spiking input signal and at least one analog input signal using a parameterized rule;
based at least in part on said at least one spiking signal and said at least one analog signal, modifying a parameter of said parameterized rule resulting in a modified parameter; and
generating an output signal by said node, based at least in part on said modifying said parameter and in accordance with said parameterized rule.

11. The method of claim 10, wherein:
the node comprises a spiking node; and
said parameter is associated with said spiking node.

12. The method of claim 11, wherein:
said parameterized rule comprises a reinforcement learning rule; and
said modified parameter is configured based at least in part on a reinforcement signal, the reinforcement signal being representative of a desired network output.

13. The method of claim 12, wherein the reinforcement signal is encoded using any of (i) spiking signal representation; and (ii) analog signal representation.

14. The method of claim 11, wherein:
said parameterized rule comprises an unsupervised learning rule; and
said modified parameter is configured based at least in part on any of said at least one spiking signal, said at least one analog signal, and said output signal.

15. The method of claim 11, wherein said parameter comprises at least one of (i) integration time constant, (ii) firing threshold, (iii) resting potential, (iv) refractory period, and/or (v) level of stochasticity associated with generation of said output signal.

16. The method of claim 11, wherein said parameter comprises at least one of (i) node excitability, (ii) node susceptibility, and/or (iii) node inhibition.

17. A computer implemented method of operating a heterogeneous neuronal network comprising a node and a plurality of synaptic connections, the method comprising:
receiving at said node, via said plurality of synaptic connections, at least one spiking input signal and at least one non-spiking input;
based at least in part on said receive, modifying at least one parameter configured to effect output generation by said node; and
generating an output signal by said node, based at least in part on said modified at least one parameter.

18. The method of claim 18, wherein modifying said at least parameter comprises , adjusting a characteristic associated with at least one connection of said plurality of synaptic connections in accordance with a parameterized rule.

19. The method of claim 18, wherein said output is encoded using a spiking representation.

20. The method of claim 18, wherein said output is encoded using analog representation.

21. The method of claim 18, wherein said at least one parameter comprises at least one of (i) synaptic strength, (ii) synaptic delay, (iii) synaptic integration time, and/or (iv) probability of transmitting said at least one spiking input signal and said at least one non-spiking input signal to said node.

22. The method of claim 18, further comprising adjusting a characteristic associated with at least one connection of said plurality of synaptic connections in accordance with a parameterized rule;
wherein:
said at least one parameter is associated with said parameterized rule; and
said characteristic is adjusted based at least in part on said modifying said at least one parameter.

23. The method of claim 22, wherein:
said at least one spiking input signal is being received via a first connection of said plurality of connections;
said at least one non-spiking input signal is being received via a second connection of said plurality of connections; and
said at least one connection comprises one of said first connection and said second connection.

24. The method of claim 23, further comprising modifying, based at least in part on said receive, one other characteristic associated with said second connection according to said parameterized rule;
wherein said at least one connection comprises said first connection.

25. The method of claim 22, wherein said parameterized rule comprises a parameterized function of said at least one parameter.

26. The method of claim 22, wherein:
said parameterized rule comprises a supervised learning rule; and
said modifying said at least one parameter is configured based at least in part on a target signal, the target signal being representative of a desired node output.

27. The method of claim 26, wherein:
said at least one spiking input signal and at least one non-spiking input are being received by said node as a part of a signal group, the group comprising a plurality of signals; and
said supervised learning rule comprises an online method configured to effect said modification prior to receipt by the node of a last signal of said plurality of signals.

28. The method of claim 26, wherein:
said at least one spiking input signal and at least one non-spiking input are being received by said node as a part of a signal group, the group comprising a plurality of signals; and
said supervised learning rule comprises an off-line method configured to delay said modifying said at least one parameter until receipt by said node of all signals of said the plurality signals.
